(19) United States
(12) Patent Application Publication
(10) Pub. No.: US 2007/0024537 A1
(43) Pub. Date: Feb. 1, 2007

(54) Drive scheme for improved device lifetime

(75) Inventors: Vi-En Choong, San Jose, CA (US); Franky So, San Jose, CA (US)

Correspondence Address: FISH & RICHARDSON P.C., PO BOX 1022, MINNEAPOLIS, MN, 55440-1022, US

(73) Assignee: Osram Opto Semiconductors GmbH

(21) Appl. No.: 11/195,260

(22) Filed: Aug. 1, 2005

(51) Int. Cl. G09G 3/30

(52) U.S. Cl. 345/76

(57) ABSTRACT

Driving passive matrix optoelectronic devices is described. Driving a passive matrix OLED display includes addressing a row of a plurality of rows during a row time of a frame. During the frame, a reverse bias is applied to all the pixels.

### BACKGROUND

The invention relates to drive schemes for optoelectronic devices. Organic light emitting diodes (OLEDs) can be superior display devices because of their contrast, flexibility, thinness, small size, reduced power consumption and improved viewing angle. However, there are still challenges in forming OLEDs. Forming desirable emitting colors has been a challenge that is being overcome with new materials. Other challenges include brightness uniformity, parasitic capacitance and lifetime. The brightness of a display typically reduces over time. Additionally, the operating voltage can increase over time. The device lifetime can depend on the materials used to form the device, the device structure, the color, the current through the device and the brightness of the device.

### SUMMARY

In one implementation, the invention relates to drive schemes for optoelectronic devices. Driving a passive matrix OLED display includes addressing a row of a plurality of rows during a row time of a frame. During the frame, a reverse bias is applied to all the pixels.

### DESCRIPTION OF DRAWINGS

FIG. 1 is a cross-sectional view of a single OLED pixel.

FIG. 2 is a plan view of an organic light emitting diode (OLED) pixel matrix.

FIG. 3A is a diagram of a column voltage waveform.

FIG. 3B is a diagram of a row voltage waveform.

FIG. 3C is a diagram of a pixel voltage difference waveform.

FIG. 4 is a diagram of voltage waveforms during a frame.

FIG. 5 is a graph comparing OLEDs run at drive schemes with and without reverse bias.

FIG. 6A is a diagram of a column voltage waveform.

FIG. 6B is a diagram of a row voltage waveform.

FIG. 6C is a diagram of a pixel voltage difference waveform.

Like reference symbols in the various drawings indicate like elements.

### DETAILED DESCRIPTION

In one implementation, the invention relates to drive schemes for optoelectronic devices. Driving a passive matrix OLED display includes addressing a row of a plurality of rows during a row time of a frame. During the frame, a reverse bias is applied to all the pixels.

Aspects of the invention may include one or more of the following features. Addressing a row can bring a potential of the row to about 0 volts. Applying a reverse bias to all the pixels can be performed by applying a high potential to all rows of the plurality of rows simultaneously. Each row can be addressed for only a single row time during the frame to cause at least one pixel in the row to light. Driving each row can include driving the rows sequentially, so that rows adjacent to one another are driven consecutively. Applying a reverse bias to all the pixels can occur more than one time per frame. A row time can comprise a predetermined period of time and a reverse bias can be applied to all the pixels for the predetermined time during the frame. Alternatively, a reverse bias can be applied to all the pixels for longer than the predetermined time. The reverse bias can be applied to all the pixels multiple times in the frame, so that the reverse bias is applied at times interspersed throughout the frame. The reverse bias can be applied to all the pixels for a sufficiently short period of time that an off time for all pixels is unnoticeable to a human observer. The reverse bias can be applied to all pixels at a voltage about equal to the forward voltage. The reverse bias can be applied to all pixels at a voltage equal to between about one half and three-quarters the forward voltage. The reverse bias can be applied when the device is in a standby or off mode. The reverse bias can be applied to all the pixels for less than about 10% of the frame. A frame can include driving N rows at (N+RB) mux (multiplex rate), wherein the rows are addressed during N row times of the frame and applying a reverse bias occurs during RB row times. The frame can occur at 60 Hz or 100 Hz. During a frame, reverse bias can be applied to all of the rows simultaneously for less than 10% of the frame.

In another implementation, the invention relates to method of driving a passive matrix device. An initial operating voltage for a device can be determined and a drive voltage for the device can be limited to about 1.0V above the initial operating voltage. Alternatively, the drive voltage can be limited to about 0.5V above the initial operating voltage.

In yet another implementation, the invention relates to method of driving an OLED device. An OLED can be selectively addressed to emit light or not emit light. Subsequent to at least one instance of addressing the OLED to emit light, a reverse bias can be applied under a predetermined controlled condition dependent on a frequency at which the OLED is addressed and/or the period during which the OLED is addressed to emit light.

Aspects of the invention may include one or more of the following features. The OLED can be a pixel in a display including a plurality of other OLEDs, and addressing the OLED can include addressing the OLED as a pixel of an image rendered by the display. Applying a reverse bias under a predetermined condition can include applying the reverse bias dependent on the frequency at which the OLED is addressed. Applying a reverse bias under a predetermined condition can include applying the reverse bias dependent on the period during which the OLED is driven to emit light. The OLED and the other OLEDs in the display can be driven during frames in which the OLED and the other OLEDs are selectively addressed to render an image, and applying the reverse bias to the OLED can occur during a frame. The method can include applying a reverse bias to a plurality of OLEDs among the other OLEDs in the display during the frame. The reverse bias can be applied to the plurality of OLEDs at multiple intervals throughout the frame. The method can include applying a reverse bias to all of the other OLEDs during the frame. The method can include applying a reverse bias during a plurality of frames in a series of frames rendering a single image. The OLED and other OLEDs in the display can be driven in frames in which the OLED is selectively addressed in rendering the image, and applying the reverse bias to the OLED can occur between frames in a series of frames. The OLED and other OLEDs in the display are driven in frames in which the OLED is selectively addressed in rendering the image, and applying the reverse bias can occur during a standby mode.

In another implementation, the invention is directed to an OLED system. The system includes an OLED and an OLED driver. The driver is arranged to selectively address the OLED to emit light or not emit light. Subsequent to at least one instance of addressing the OLED to emit light, a reverse bias is applied under a predetermined controlled condition dependent on the frequency at which the OLED is addressed and/or the period during which the OLED is addressed to emit light

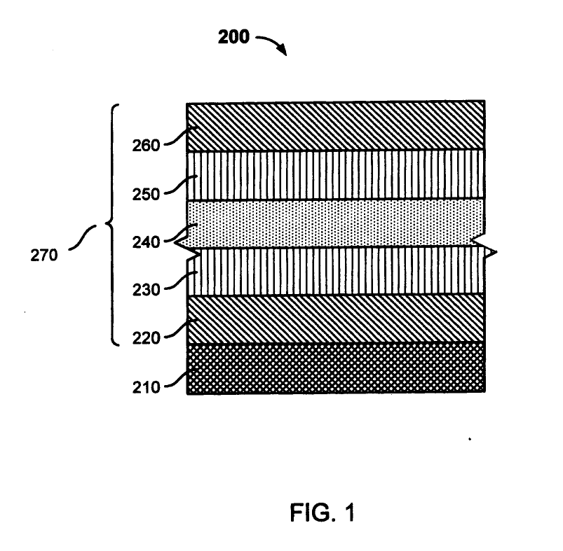

FIG. 1 refers to an exemplary cross-sectional view of an OLED pixel 200. In one implementation, the OLED pixel 200 contains a substrate 210 and a light emitting stack 270. The substrate 210 can be made of a transparent material, such as glass or plastic. In the implementation shown, the light emitting stack 270 includes an anode layer 220, a hole transport layer 230, an emissive layer 240, an electron transport layer 250 and a cathode layer 260. The anode layer 220 is deposited on the substrate 210. The anode layer 220 can include a transparent electrically conductive material, such as indium tin oxide (ITO). The hole transport layer 230 is deposited on the anode layer 220. The hole transport layer 230 can include, but is not limited to, a conductive polymer such as polyethylenedioxythiophene (PEDOT) and polyaniline (PANI). In some instances, this layer is also referred to as the hole injecting layer or is part of the anode. The emissive layer 240 is deposited over the hole transport layer 230. The emissive layer 240 can include a material capable of fluorescing/phosphorescing and can include, but is not limited to, conjugated EL polymers, such as polyfluorenes, polythiophenes, polyphenylenes, polythiophenevinylenes, or poly-p-phenylenevinylenes or their families, copolymers, derivatives, or mixtures thereof. The electron transport layer 250 is deposited over the emissive layer 240. Some examples of electron transport materials are 2-(4-tert-butylphenyl)-5-(4-biphenylyl)-1,3,4-oxadiazole (PBD), spiro-2-(biphenyl-4-yl)-5-(tert-butylphenyl)-1,3,4-oxadiazole or other oxadiazoles, Polyquinoline and its derivatives, N,N′-Bis(4-(2,2-diphenylethen-1-yl)phenyl)-N,N′-bis(4-methylphenyl)benzidine. The cathode layer 260 is deposited over the electron transport layer 250. Many materials can function as a cathode, such as compositions that include aluminum, indium, silver, gold, magnesium, calcium, lithium, lithium fluoride, cesium fluoride, sodium fluoride, and barium, or combinations thereof, or alloys thereof.

A voltage is applied to the anode layer 220 and to the cathode layer 260. When the voltage at the anode layer 220 is different from the voltage at the cathode layer 260, an electric field forms across the light emitting stack 270. When the voltage at the anode layer 220 is sufficiently higher than the voltage at the cathode layer 260, the electric field causes negative charges (electrons) to be released from the cathode layer 260 and move toward the anode layer 220. Simultaneously, positive charges (holes) are released from the anode layer 220 and move toward the cathode layer 260. The positive and negative charges can combine in the emissive layer 240, releasing photons and causing light to be emitted. OLEDs are further discussed in U.S. Publication No. 2004/0046500, the entire contents of which is hereby incorporated by reference.

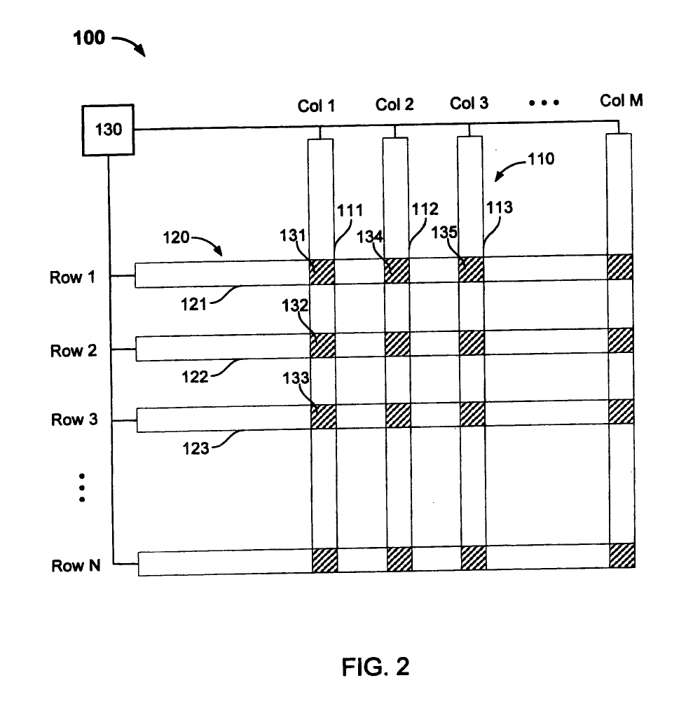

FIG. 2 depicts an exemplary organic light emitting diode (OLED) pixel matrix 100. The OLED pixel matrix 100 contains a set of anodes 110, configured in columns, and a set of cathodes 120, configured in rows. The OLED pixel matrix 100 contains M columns of anodes 110 and N rows of cathodes 120. An OLED pixel 131 is located at the intersection between an anode 111 and a cathode 121. In one mode, the anode 111 is electrically connected to a voltage source and the cathode 121 is connected to electrical ground, causing the OLED pixel 131 to be biased at a forward bias. The potential drop across the OLED pixel 131 causes the OLED pixel 131 to emit light, as described further below. In another mode, the anode 111 is brought to approximately zero voltage and the cathode 121 is biased so that the OLED pixel 131 is at a reverse bias, during which the OLED pixel 131 does not emit light. In yet another mode, when the anode 111 potential and the cathode 121 potential are approximately equal, a neutral bias occurs across OLED pixel 131 and it does not emit light. If the difference between the pixels is below a threshold necessary to cause the OLED pixel 131 to emit light, such as a voltage drop of about 2V or less, the OLED pixel 131 does not emit light.

In at least one embodiment of the invention, the device is operated in a manner that enhances its lifetime and reduces degradation. In particular, the lifetime is increased by controlled application of reverse bias and/or voltage limits during operation. Controlled conditions for applying reverse bias can include applying reverse bias either during each frame, at the beginning or end of each frame or during an off or standby time. The time in which all the rows are addressed in a passive matrix device is a frame. Where reverse bias is applied during a frame, the reverse bias can be applied in every frame. Alternatively, the reverse bias can be applied in only selected frames. The existence of ions or detrimental moieties in the polymers can degrade the device during constant operation. In particular, the detrimental moieties near the anode can be pushed from the anode into the polymer during operation and degrade the polymer. The device may degrade in part due to polarizing of the device. Over time, the operating voltage increases. The increasing voltage can indicate that the device is becoming polarized or that the material is degrading, thus changing the device characteristics. The reverse bias and voltage limiting method can be applied systematically to all OLED pixels in a pixel display matrix.

Imposing a reverse bias to the pixels equilibrates or can redistribute charges in a device. When the device is under reverse bias, the charge build up may be reduced. In particular, controlling the reverse bias that is applied to the device can extend the lifetime of the device over a similar device that is driven without reverse bias. In addition, as the organic materials of the device degrade, they increase in resistance. Thus, more voltage is required to maintain the current level of the device during operation. As the voltage into the device increases, the rate of degradation of the organic materials can increase. Any voltage or electric field induced damage is added to the normal luminance degradation. This damage can prompt a further increase in the operating voltage, and even accelerate the rate of voltage increase which in turn accelerates the device degradation. Thus, by limiting the amount of forward bias voltage supplied to the device, this destructive effect can be averted. This can be achieved by limiting the maximum drive voltage, such as to 2.0V, 1.0V or 0.5V above the initial operating voltage. At the beginning of the device lifetime, the device runs in constant current mode. As the device degrades and requires more voltage, the maximum drive voltage will be reached. The device is then forced to run in constant voltage mode. Here, the current supplied to the device starts to decrease, and contribute to the dimming of the device. Although the device may begin to dim, the dimming over time will be slower than a similar device where the operating voltage is not limited.

In some embodiments, the OLED pixel matrix 100 is a passive matrix device and is multiplexed. In an active matrix device, any pixel in the matrix can be turned on or off within a single instant. In a passive matrix device, all of the electrodes aligned in a first direction, for example, the columns, are individually controlled at all times, while the electrodes aligned in a second direction, for example, the rows, are addressed one at time. Thus, only pixels in a single row can be turned on in a single instant. Addressing two rows at a time would remove individual control of pixels in the two rows. Addressing two rows at once would expose the pixels in each column of the two rows to the same biasing conditions, and thus, the pixels would be either on or off together. The multiplex rate (“mux”) can be equal to or higher than the number of rows in the device. As an example, when the addressing time for a device having 5 columns and 6 rows is distributed among the 6 rows, the driving condition is referred to as 6 mux. Addressing a row is by definition activating that row. When a row is activated, the pixels on that row are enabled to either emit light or remain dark depending on the potential applied to the column. Each row in the matrix is addressed within a frame. In operation, a frame is followed by a next frame. A picture on the display is refreshed at a certain frequency, such as 100 Hz, that is, the display shows 100 frames per second. The frame refresh rate is not limited to 100 Hz, the frames can be refreshed at any desired refresh rate.

In at least one embodiment, the row signal sent into each row is independent of the pixels to be lit on the display. Rather, the voltage of the columns, or cathodes 110, determines whether a pixel in a row lights up. The function of the row voltage is merely to control whether a row is addressed. In one embodiment, as each row is addressed, the row is brought from a high voltage to a low voltage, that is ground or approximately ground.

The OLED pixel matrix 100 is driven by a driver 130 which applies appropriate signals to the anodes and cathodes. The driver is a component that applies different potentials to all anodes 110 and cathodes 120 to light up the required pixels for a desired pattern. As described above, in some passive matrix addressing schemes, only one row is activated at any one time, while all columns are always activated. The pixels on all unactivated rows remain off regardless of the potential applied on the column. The driver can include software and/or hardware. The driver 130 can be configured to apply the controlled reverse bias according to any of the selected drive schemes described herein.

As an example of operating a device, all columns are always activated, and high or low potential (corresponding to on or off pixels) are applied to the columns based on the image to be displayed. Then, a first row is addressed and the pixels that intersect with the high potential columns become forward biased and emit light. After the time for addressing the row (the row time) has ended, the first row is de-activated and a second row is addressed or activated. For example, the multiplexing can begin with a high voltage applied to both the anodes 110 and the cathodes 120. In this case, all the pixels are off. To light only pixel 131 in the first row, the first column (anode 111) is kept at a high voltage and a second column (anode 112) and a third column (anode 113) are brought to a low voltage. Then, a first row (cathode 121) is activated, bringing row 1 to a low voltage. This causes only OLED pixel 131 to be forward biased and emit light, while pixels 134, 135 are neutrally biased and do not emit light. Other pixels that intersect with the first column (anode 111) and with rows other than the first row 1 are in a reverse bias state, and therefore do not light up when the first row 1 is being addressed. In embodiments, the low voltage can be in a range between −2 and 0V or between 0 and 2V. The high voltage can be as high as 20 V and as low as 5 V, depending on the brightness required. The voltage can be in a range between 4 and 15V, between 6 and 12V, or between 6 and 8V. After the row time for the first row is over, row 2 (cathode 122) is now addressed, and the columns are reset for the second row time.

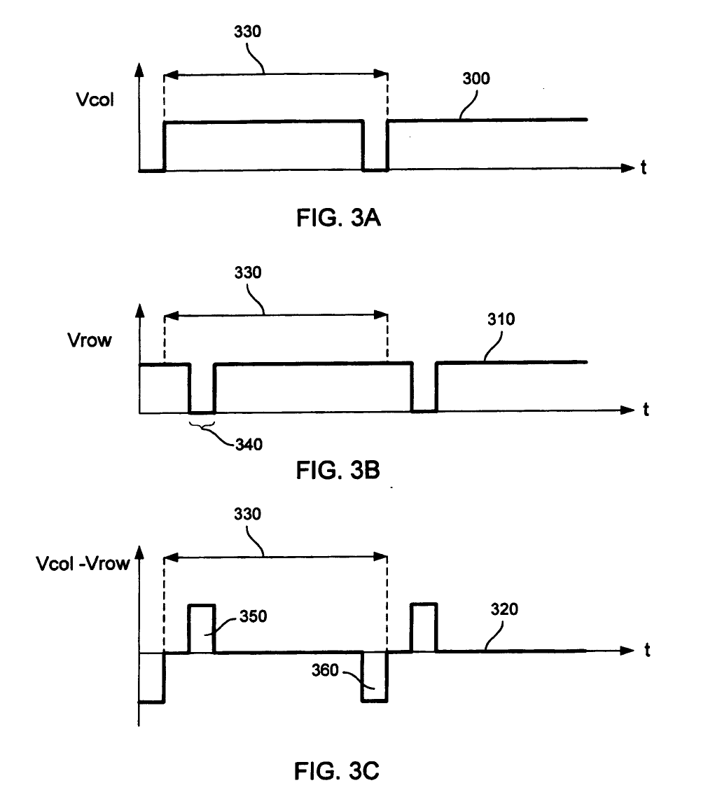

FIGS. 3A, 3B, and 3C show voltage waveforms for the OLED pixel matrix 100. FIG. 3A shows an anode voltage waveform 300, that is, the voltage that is applied to any one of the anodes 110, such as anode 111, of the OLED pixel matrix 100 when all the pixels that intersect with the anode are to be turned on. FIG. 3B shows a cathode voltage waveform 310 that is applied to, for example, the second cathode 122 of the OLED pixel matrix 100. FIG. 3C shows a pixel voltage difference waveform 320 which is the result of subtracting cathode voltage waveform 310 from the anode voltage waveform 300. The pixel voltage difference waveform 320 shows the potential that is experienced at the pixel located at the intersection of the anode 111 and the cathode 122.

Frame 330 is the time necessary to serially activate all rows in the matrix, and row time 340 is the time that a single row is addressed or maintained at a low voltage condition. Here, the row time 340 indicates the time during which cathode 122 is addressed. During the row time 340, the column voltage waveform 300 is high while the row voltage waveform 310 is low. The result, as depicted on the pixel voltage difference waveform 320, is a forward bias 350 across an intersecting pixel that causes light to be emitted. When the column voltage waveform 300 is high and the row voltage 310 is high, the pixel voltage difference waveform 320 shows no net applied voltage, and the intersecting pixel does not emit light because it is in a neutral state. At the end of the frame 330, a new frame can begin.

When the anode is at a low voltage and the cathode 122 is at a high voltage, the intersecting pixel is reverse biased and the pixel does not emit light. The column voltage waveform 300 is low and the row voltage waveform 310 is high at this time. The pixel voltage difference waveform 320 shows when a reverse bias condition 360 is occurring. The reverse bias condition 360 can be purposely imposed to one or more pixels, such as all the pixels in the matrix. This reverse bias condition can be imposed at the beginning or end of each frame, or interspersed in the frame. For example, if a reverse bias duration of four row times is desired for a display with N rows, then a frame now consists of (N+4) row time segments. The four row times when the entire display is under reverse bias can then be distributed in any fashion in the frame.

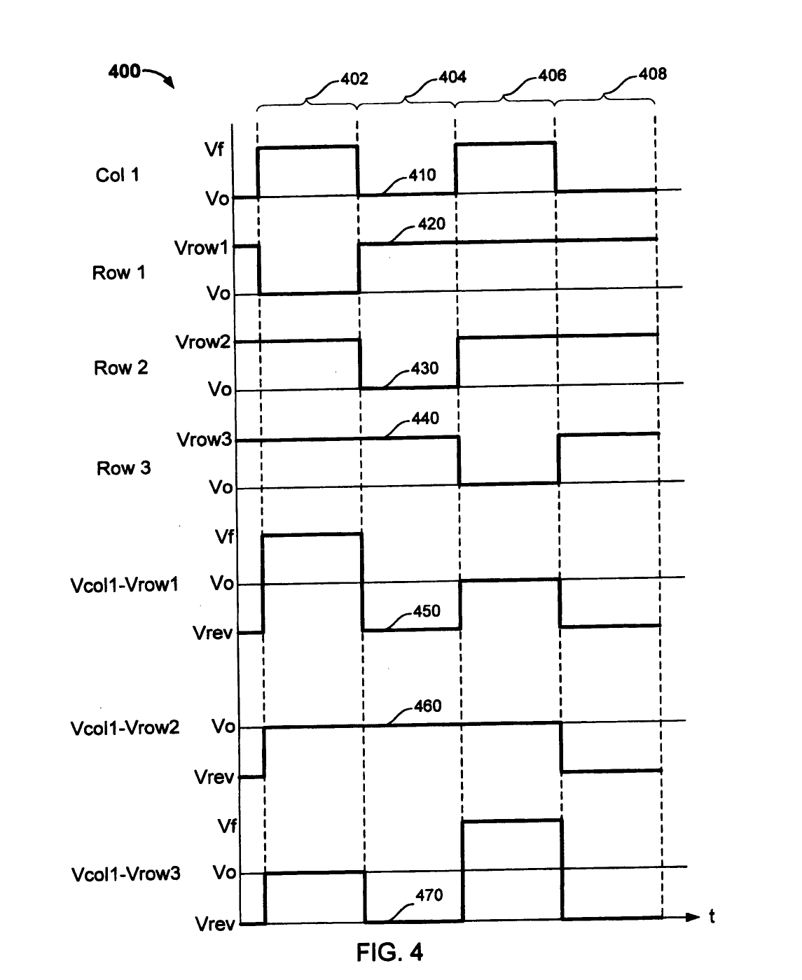

FIG. 4 shows a timing diagram 400 that can be applied to OLED pixel matrix 100. A column voltage waveform 410 and three row voltage waveforms 420, 430, 440 are represented on the timing diagram 400, and the waveforms respectively correspond to the first column (anode 111) and the first three rows (cathode 121, 122, 123) of the OLED pixel matrix 100. The voltage signals applied to the OLED pixels 131, 132, 133 are represented by pixel voltage difference waveforms 450, 460, 470. A first row time 402, a second row time 404, a third row time 406, and a fourth row time 408 represent the components of an exemplary frame 330 as shown in the timing diagram 400.

During the first row time 402, column 1 is at high voltage, row 1 is at low voltage, row 2 is at high voltage, and row 3 is at high voltage. The result is depicted in pixel voltage difference waveforms 450, 460, 470. Referring to the OLED pixel matrix 100, pixel 131 is forward biased and emits light, while pixels 132, 133 are neutrally biased and do not emit light.

During the second row time 404, column 1 is at low voltage, row 1 is at high voltage, row 2 is at low voltage, and row 3 is at high voltage. The result is that pixel 131 is reverse biased and does not emit light, pixel 132 is in a neutral state and does not emit light, and pixel 133 is reverse biased and does not emit light.

During the third row time 406, column 1 is at high voltage, row 1 is at high voltage, row 2 is at high voltage, and row 3 is at low voltage. The result is that pixels 131 and 132 are in a neutral state and do not emit light, and pixel 133 is forward biased and emits light.

During the fourth row time 408, a reverse bias is imposed at each pixel in the matrix. Column 1 is at low voltage, and rows 1, 2 and row 3 are at high voltage. The result is that pixels 131, 132, 133 are reverse biased and do not emit light. During this time, the electric field drives the negative charges (electrons) toward the cathode and positive charges (holes) toward the anode.

As demonstrated by waveforms 450 and 470, a reverse bias condition can occur during the normal operation of a device. The reverse bias condition that occurs during the second row time 404 is due to the column being brought to ground while the rows not being addressed are at high voltage. The reverse bias condition that occurs during normal operation of the device due to pixels that are turned off can be considered as occurring randomly, because the pixels that receive reverse bias depend on whether the other pixels in the same column are turned off during a frame. Depending on the image to be displayed, that is, the pixels of the matrix that are to be lit, a pixel may or may not experience reverse bias at any time during device operation. Moreover, some pixels in the display may never experience a reverse bias condition, while other pixels may experience a reverse bias condition frequently. The more pixels in a column that are turned off, the more time the pixels in that column see reverse bias. If all pixels in a column are never off, the pixels in that column will never see any reverse bias. A reverse bias can be imposed for pixels in a controlled manner, such as periodically for all of the pixels in the device, to ensure that each pixel experiences reverse bias for some percentage of device operation as illustrated in FIG. 4 where the reverse bias is imposed at the end of the frame.

The controlled application of reverse bias to the display can depend on the period during which the device is driven. In some embodiments, the controlled application of reverse bias depends on the frequency at which the device is addressed.

In at least one embodiment, the time during which reverse bias is imposed on the pixels can be equivalent to as little as one row time, and as large as 2N row time where N is the number of rows in the display. The number of reverse bias row times can be chosen based on how much reverse bias time is needed for that display, and whether the display appears to flicker due to the off times. Though reverse bias times that are fractions of row time are possible, it is simpler to use reverse bias segments equal to multiples of row time. For example, if one row time of reverse bias is desired for the OLED matrix 100 with 54 rows, the matrix will be driven at 55 mux. The additional row time can be located anywhere in the frame. In some cases, a longer reverse bias may be desirable. This can be achieved by driving the display at 60 mux, where 54 row times drive the 54 rows and 6 row times are used to apply a reverse bias to the whole display, and the six row times can be interspersed throughout the frame 330. For example, a reverse bias may be applied after each of rows 9, 18, 27, 36, 45, and 54 have been activated. As described above, the mux rate is at least the number of rows in a device. Thus, the mux rate depends at least in part on the pixel matrix.

Other drive schemes with reverse bias can be used to drive the device. Reverse bias may be applied any time that the display is in standby mode or off. The standby or off mode can be the time when no image is being displayed. Reverse bias may also be applied at a combination of standby mode or off time and during or between frames. A drive scheme including reverse bias conditions ideally keeps the reverse bias time sufficiently short so that the off time of the device is not noticeable to a human viewing the device. In some implementations, the reverse bias time is limited to about 10% or less than the total on-time of the device. The operating frequency of the device can also contribute to whether the reverse bias time is noticeable to the human eye. A display typically runs at a rate of greater than 60 Hz, such as at 100 Hz, to prevent adverse display quality cause by a slow refresh rate.

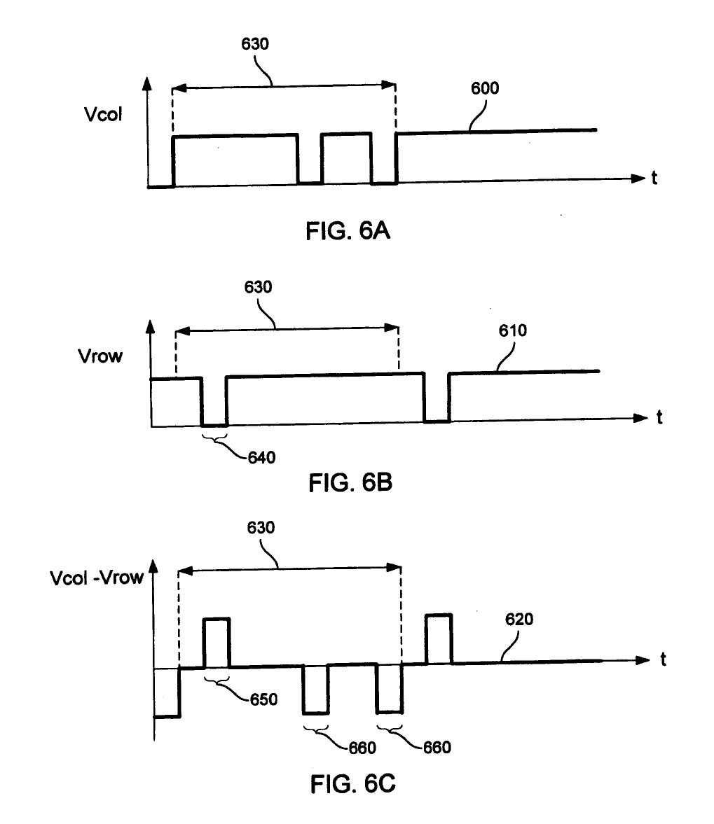

FIG. 6A, FIG. 6B, and FIG. 6C show voltage waveforms for the OLED pixel matrix 100 where the reverse bias time is interspersed throughout the frame. Similar to FIG. 3A-3C, a column voltage waveform 600, a row voltage waveform 610, and a pixel voltage difference waveform 620 are depicted. Frame 630 is the time period for serially accessing all rows, and row time 640 is the time period of a forward bias 650. Referring to FIG. 6A-6C, two separate reverse biases 660 are created by setting the column voltage waveform low and keeping the row voltage waveform high within the frame 630.

The reverse bias can be equal to the forward bias that is applied to drive the device. In one implementation, the reverse bias can be less than the forward bias that is applied to drive the device, such as between one half and three-fourths of the forward voltage or less.

Systematically imposing a reverse bias to a pixel may equilibrate or redistribute charges in a device. When the device is under reverse bias, charge build up may be reduced. In particular, controlling the reverse bias that is applied to the device can extend the lifetime of the device over a similar device that is driven without exposure to reverse bias either during each frame, between frames or during an off or standby time. Further, limiting the amount of forward bias voltage may limit the diffusion of mobile ions, because ionic diffusion is field dependent. Dimming of the device over time may be slower than a similar device with a higher operating voltage if the voltage is not limited.

### EXAMPLE

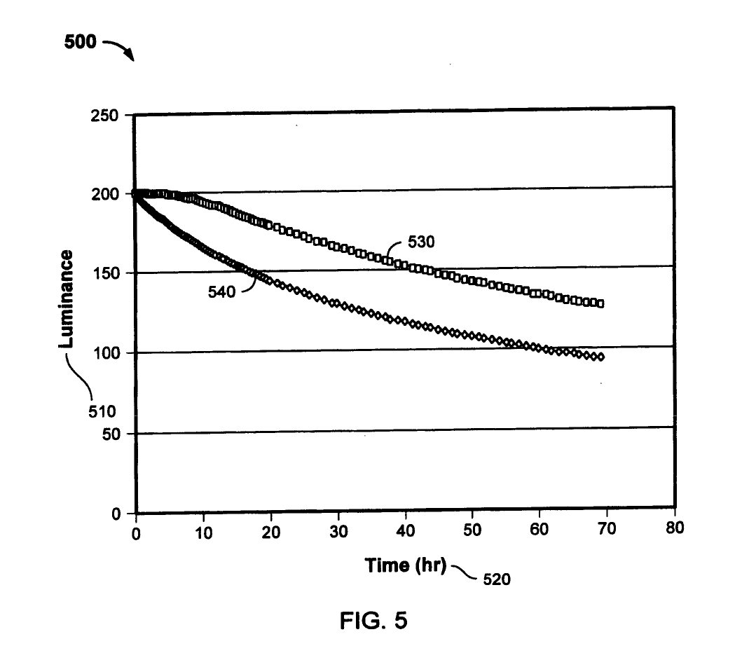

FIG. 5 shows a graph 500 depicting the performance of two OLED devices. Each device is fabricated on a 0.7 mm glass substrate. A transparent anode layer of 100 nm of ITO is deposited on the substrate. A hole transport layer of 200 nm of conductive polymer, made of poly(3,4-ethylenedioxythiophene) doped with poly(styrene sulphonate), was deposited on the anode layer. An emissive layer of 80 nm of a polyfluorene based polymer was deposited on the hole transport layer. The cathode layer of 2 nm of barium capped with 200 nm of aluminum was deposited on the emissive layer. A 1.1 mm cover glass was placed over the cathode layer and sealed to the substrate. The devices were single pixel devices.

Each of the two OLED devices was operated under identical conditions at an environmental temperature of 70 degrees Celsius. The forward bias voltage value was 8V and the reverse bias voltage value was 6V. Each of the two OLED devices was operated at 54 mux, that is, the single pixel of the device was treated as though it were addressed for 1/54^{th} of the frame time. One OLED device was operated with positive pulses (forward biasing) during each frame and no bias was applied during off periods. The other OLED device was operated with positive pulses (forward biasing) and a reverse bias during off periods (in the frame). Therefore, the OLED pixel of the first single pixel device was on for 1/54th of the frame and off for 53/54th of the frame (without reverse bias). The OLED pixel of the second single pixel device was on for 1/54th of the frame and off for 53/54th of the frame, but with a reverse bias applied during the off time.

The graph 500 shows the luminance data obtained from the two OLED devices. The y-axis represents a luminance range 510 and the x-axis represents an operating time 520. A non-reverse biased data curve 540 represents the luminance data measured from the OLED device with no reverse bias exposure during the frame. A reverse biased data curve 530 represents the luminance data measured from the OLED device that was reverse biased during all off times of the frame.

During the operating time range 540, the reverse bias data curve 530 decayed slower than the non-reverse bias data curve 540. The OLED device driven with reverse bias reached about 75% of initial luminance in more than twice the time it took for the non-reverse biased device to reach 75% of the initial luminance. Due to material lifetime factors, both curves 530, 540 show decreasing luminance over the operating time range 520. However, the device that was driven with an applied reverse bias decayed slower, and therefore has a longer lifetime.

A number of embodiments of the invention have been described. Nevertheless, it will be understood that various modifications may be made without departing from the spirit and scope of the invention. For example, the methods described herein can be applied to an active matrix device. Accordingly, other embodiments are within the scope of the following claims.

What is claimed is:

1. A method of driving a passive matrix OLED display, comprising:
during a row time of a frame, addressing a row of a plurality of rows; and
during the frame, applying a reverse bias to all the pixels.

2. The method of claim 1, wherein addressing a row brings a potential of the row to about 0 volts.

3. The method of claim 1, wherein applying a reverse bias to all the pixels is performed by applying a high potential to all rows of the plurality of rows simultaneously.

4. The method of claim 1, wherein:
a row time comprises a predetermined period of time; and
applying a reverse bias to all the pixels applies the reverse bias for the predetermined time during the frame.

5. The method of claim 1, wherein:
a row time comprises a predetermined period of time; and
applying a reverse bias to all the pixels applies the reverse bias for longer than a row time during the frame.

6. The method of claim 5, wherein applying a reverse bias to all the pixels includes applying the reverse bias to all the pixels more than one time during the frame, so that the reverse bias is applied at times interspersed throughout the frame.

7. The method of claim 5, wherein applying the reverse bias to all the pixels is for a sufficiently short period of time that an off time for all pixels is unnoticeable to a human observer.

8. The method of claim 1, wherein the reverse bias applied to all pixels is at a voltage about equal to the forward voltage.

9. The method of claim 1, wherein the reverse bias applied to all pixels is at a voltage equal to between about one half and three-quarters the forward voltage.

10. The method of claim 1, further comprising applying the reverse bias when the device is in standby or off mode.

11. The method of claim 1, wherein addressing a row includes applying a forward voltage to at least one pixel in the row, the method further including limiting the forward voltage to one volt above an initial operating voltage.

12. The method of claim 11, wherein the forward voltage is limited to about 0.5 volts above an initial operating voltage.

13. The method of claim 1, wherein a frame includes driving N rows at (N+RB) mux, wherein the rows are addressed during N row times of the frame and applying a reverse bias occurs during RB row times.

14. A method of driving a passive matrix device, comprising:
determining an initial operating voltage for a device; and
limiting drive voltage for the device to about 1.0V above the initial operating voltage.

15. The method of claim 14, wherein limiting the drive voltage include limiting the drive voltage to about 0.5V above the initial operating voltage.

16. A method of driving an OLED device, comprising:
selectively addressing an OLED to emit light or not emit light; and
subsequent to at least one instance of said addressing said OLED to emit light, applying a reverse bias under a predetermined controlled condition dependent on a frequency at which said OLED is addressed and/or the period during which the OLED is addressed to emit light.

17. The method of claim 16, wherein the OLED is a pixel in a display including a plurality of other OLEDs, and addressing said OLED includes addressing the OLED as a pixel of an image rendered by the display.

18. The method of claim 17 wherein applying a reverse bias under a predetermined condition includes applying the reverse bias dependent on the frequency at which the OLED is addressed.

19. The method of claim 17, wherein applying a reverse bias under a predetermined condition includes applying the reverse bias dependent on the period during which the OLED is driven to emit light.

20. The method of claim 17, wherein the OLED and other OLEDs in the display are driven during frames in which said OLED and other OLEDs are selectively addressed to render an image, and applying said reverse bias to said OLED occurs during a frame.

21. The method of claim 20 further comprising applying a reverse bias to a plurality of OLEDs among said other OLEDs in said display during said frame.

22. The method of claim 21 wherein applying said reverse bias to said plurality of OLEDs occurs at multiple intervals throughout said frame.

23. The method of claim 21 further comprising applying a reverse bias to ail of said other OLEDs during said frame.

24. The method of claim 17 wherein said OLED and other OLEDs in the display are driven in frames in which said OLED is selectively addressed in rendering the image, and applying said reverse bias to said OLED occurs between frames in a series of frames.

25. The method of claim 17 wherein the OLED and other OLEDs in the display are driven in frames in which said OLED is selectively addressed in rendering the image, and applying said reverse bias occurs during standby mode.

26. An OLED system, comprising:
an OLED, and
an OLED driver, said driver arranged to selectively address the OLED to emit light or not emit light, and subsequent to at least one instance of said addressing said OLED to emit light, applying a reverse bias under a predetermined controlled condition dependent on the frequency at which said OLED is addressed and/or the period during which the OLED is addressed to emit light.
